(19) United States
(12) Patent Application Publication
(10) Pub. No.: US 2026/0172611 A1
(43) Pub. Date: Jun. 18, 2026

(54) Improved Entropy Bypass Coding

(71) Applicant: Google LLC, Mountain View, CA (US)

(72) Inventors: Joseph Young, Mountain View, CA (US); In Suk Chong, Mountain View, CA (US); Debargha Mukherjee, Cupertino, CA (US); Jingning Han, Santa Clara, CA (US); Aki Kuusela, Palo Alto, CA (US)

(21) Appl. No.: 19/123,598

(22) PCT Filed: Oct. 24, 2023
(86) PCT No.: PCT/US2023/077618

§ 371 Date: Apr. 23, 2025

Related U.S. Application Data
(60) Provisional application No. 63/419,164, filed on Oct. 25, 2022.

(51) Int. Cl. H04N 19/91; H04N 19/184

(52) U.S. Cl. CPC H04N 19/91; H04N 19/184

(57) ABSTRACT

Bypass decoding by an arithmetic decoder is disclosed. A request to decode a number of binary bits from a compressed bitstream is received. Each of the binary bits is equi-probable. The arithmetic decoder maintains an offset and a range. A decoding range is established based on the range. The binary values for the binary bits are decoded by: for each binary bit of the binary bits, performing the steps of comparing the offset to a midpoint of the decoding range to determine a binary value for the each binary bit, where the binary value is decoded from the compressed bitstream; conditionally updating the midpoint based on the comparing; and halving the midpoint so that an equi-probability is maintained for decoding a next binary bit subsequent to the each binary bit. The binary values of the binary bits are then provided.

### CROSS REFERENCE TO RELATED APPLICATION

This application claim priority to and the benefit of U.S. Provisional Patent Application Ser. No. 63/419,164, filed Oct. 25, 2022, the entire disclosure of which is incorporated herein by reference.

### BACKGROUND

Digital video streams may represent video using a sequence of frames or still images. Digital video can be used for various applications including, for example, video conferencing, high-definition video entertainment, video advertisements, or sharing of user-generated videos. A digital video stream can contain a large amount of data and consume a significant amount of computing or communication resources of a computing device for processing, transmission, or storage of the video data. Various approaches have been proposed to reduce the amount of data in video streams, including compression and other encoding techniques.

Encoding based on motion estimation and compensation may be performed by breaking frames or images into blocks that are predicted based on one or more prediction blocks of reference frames. Differences (i.e., residual errors) between blocks and prediction blocks are compressed and encoded in a bitstream. A decoder uses the differences and the reference frames to reconstruct the frames or images.

### SUMMARY

In one general aspect, a method may include receiving a request to decode a number of binary bits from a compressed bitstream, where each of the binary bits is equi-probable, and where the arithmetic decoder maintains an offset and a range. Method may also include establishing a decoding range based on the range. The method may further include decoding binary values for the binary bits by: for each binary bit of the binary bits, performing steps of comparing the offset to a midpoint of the decoding range to determine a binary value for the each binary bit, where the binary value is decoded from the compressed bitstream; conditionally updating the midpoint based on the comparing; and halving the midpoint so that an equi-probability is maintained for decoding a next binary bit subsequent to the each binary bit. The method may in addition include providing the binary values of the binary bits. Other embodiments of this aspect include corresponding computer systems, apparatus, and computer programs recorded on one or more computer storage devices, each configured to perform the actions of the methods.

Another general aspect is a method for encoding binary values. The method includes initializing an offset and a decoding range; receiving a binary value and a specified number of bits within which the binary value is to be encoded, where the specified number of bits is limited to a predetermined maximum value; adjusting the offset to obtain an adjusted offset based on the binary value and the specified number of bits by performing a leftward bit shift operation on the offset followed by an addition of a product of the decoding range and the binary value; and outputting bits in a compressed bitstream based on the adjusted offset.

Another general aspect is a method for bypass coding that includes receiving a number of bits to code; calculating a midpoint value of a range to obtain a cumulative distribution function; conditionally subtracting the midpoint from an offset; and normalizing at least one of the range or the offset.

These and other aspects of the present disclosure are disclosed in the following detailed description of the embodiments, the appended claims and the accompanying figures. It will be appreciated that aspects can be implemented in any convenient form. For example, aspects may be implemented by appropriate computer programs which may be carried on appropriate carrier media which may be tangible carrier media (e.g., disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

### BRIEF DESCRIPTION OF THE DRAWINGS

The description herein makes reference to the accompanying drawings described below, wherein like reference numerals refer to like parts throughout the several views.

FIG. 1 is a schematic of a video encoding and decoding system.

FIG. 2 is a block diagram of an example of a computing device that can implement a transmitting station or a receiving station.

FIG. 3 is a diagram of a video stream to be encoded and subsequently decoded.

FIG. 4 is a block diagram of an encoder according to implementations of this disclosure.

FIG. 5 is a block diagram of a decoder according to implementations of this disclosure.

FIG. 6 is a flowchart diagram of a technique for bypass coding of equi-probable symbols.

FIG. 7A is a diagram of decoding a bypass symbol according to implementations of this disclosure.

FIG. 7B is a diagram of encoding a single-bit bypass symbol according to implementations of this disclosure.

FIG. 7C is a diagram of encoding a multi-bit bypass symbol according to implementations of this disclosure.

FIG. 8 is a flowchart diagram of a technique for bypass decoding of equi-probable symbols.

FIG. 9 is a flowchart diagram of a technique for bypass encoding of equi-probable symbols.

FIG. 10A illustrates a traditional technique for encoding a bypass symbol in a compressed bitstream.

FIG. 10B illustrates a traditional technique for decoding a bypass symbol from a compressed bitstream.

### DETAILED DESCRIPTION

In an encoded video bitstream, many of the bits are used for one of two things: either content prediction (e.g., inter mode/motion vector coding, intra prediction mode coding, etc.) or residual coding (e.g., transform coefficients). For example, bits may be used for coding symbols (also referred to as syntax elements) corresponding to prediction mode information and parameters and to transform coefficients. Entry coding (e.g., an arithmetic coder (AC)) can be used to losslessly code the symbols.

Entropy coding is a technique for lossless coding of symbols that relies upon probability models that model the distribution of values occurring in an encoded video bitstream. By using probability models based on a measured or estimated distribution of values, entropy coding can reduce the number of bits required to represent video data close to a theoretical minimum. In practice, the actual reduction in the number of bits required to represent video data can be a function of the accuracy of the probability model, the number of bits over which the coding is performed, and the computational accuracy of fixed-point arithmetic used to perform the coding.

For some symbols, the AC may obtain (e.g., use or select) a probability distribution based on or using a model. A model can be any parameter or method that affects probability estimation for the purpose of entropy coding. In an example, a two-pass process to learn the probabilities for a current frame may be used. In another example, a model may define a certain context derivation method.

Other symbols may be coded in what is referred to as bypass coding. Bypass coding refers to the process of arithmetic coding without using an adaptive model. Bypass coding may be used for equi-probable symbols (also referred to as bypass symbols) where each of the possible values of the symbol have the same probability of occurring. As such, for a binary symbol or bin of a symbol, a probability of 0.5 may be assumed for both symbol values (0 and 1). This equality of probabilities eliminates the need for the complex probability estimation typically required in adaptive models, thereby simplifying the encoding process and reducing computational demand.

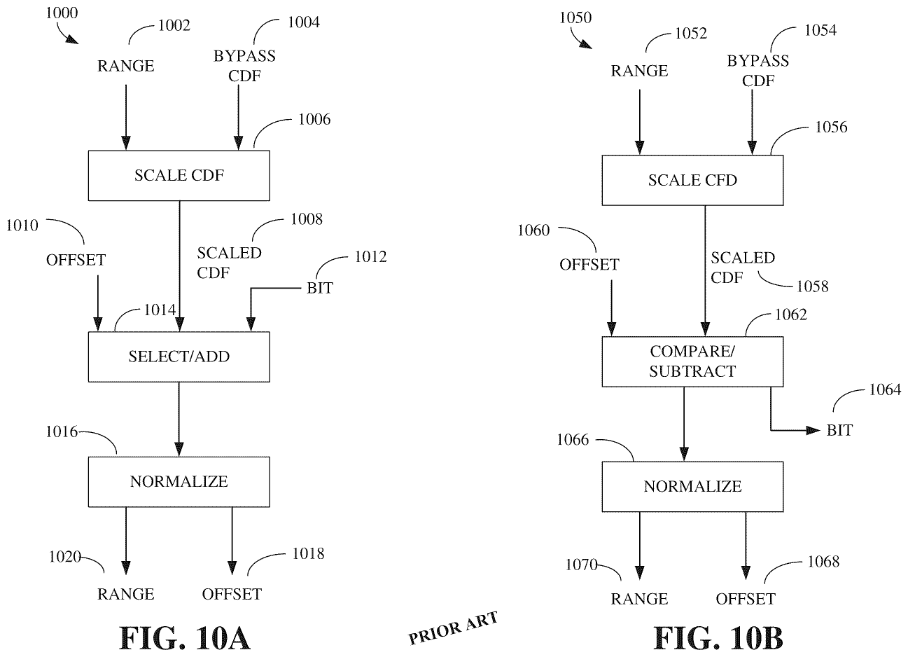

Bitstream parsing is often a bottleneck in decoding or encoding compressed video streams. To illustrate, a hardware-implemented codec may be limited to coding (encoding or decoding) 1 or 2 symbols per cycle. FIGS. 10A-10B illustrate traditional techniques for, respectively, encoding and decoding bypass symbols.

FIG. 10A illustrates a traditional technique 1000 for encoding a bypass symbol in a compressed bitstream. The bypass symbols may include (e.g., may be composed of) multiple bits. Bypass encoding makes use of a cumulative distribution function (CDF). A CDF represents the probability that a random variable is less than or equal to a certain value. In the context of bypass encoding, the CDF is typically uniform because it deals with equi-probable symbols, meaning it assumes a consistent probability distribution for all potential outcomes or symbol values. A CDF allows for the calculation of intervals within which symbol values reside, thereby guiding the encoding and subsequent decoding of these symbols in a compressed bitstream.

Scaling the CDF is a critical part of the traditional technique 1000. Scaling involves adjusting the range of the CDF to ensure that it accurately represents the probabilities of the various symbols within the specific context of the data being encoded or decoded. For example, by repeatedly scaling the CDF, the arithmetic coder can maintain precision and ensure that each symbol is assigned a proportionate range on the probability scale, which directly correlates to its occurrence likelihood.

A CDF scaling function 1006 receives a range 1002 of a current entropy “range” value and a CDF 1004. The CDF 1004 can be initialized (such as prior to any scaling operation) to the fixed CDF {32768, 16384, 0}. As the encoding of bits advances, the CDF scaling function 1006 dynamically adjusts the CDF to align with the current entropy range value, that is, the range 1002. The range 1002 can be useful in maintaining an accurate representation of the width of the current interval utilized for encoding a current bit. The range essentially functions as a dynamic threshold that adjusts based on the data being processed. The range 1002 is typically expressed as a single number that represents (e.g., indicates) the upper bound of possible values that a symbol is statistically likely to take on.

The CDF scaling function 1006 outputs a scaled CDF 1008. The scaled CDF 1008 can be given by {range, midpoint, 0}, where the midpoint value is calculated as: midpoint=od_ec_prob_scale(16384, range, 1) and where, in an example implementation, the function can be given by the code of Table I, where EC_PROB_SHIFT is the number of bits to reduce the CDF precision during arithmetic coding and EC_MIN_PROB is the minimum probability assigned to each symbol during arithmetic coding. In an example, EC_PROB_SHIFT can be set to 6 and EC_MIN_PROB can be set to 4.

TABLE I

```
unsigned od_ec_prob_scale(uint16_t p, unsigned r, int n) {
  return (((r >> 8) * (uint32_t)(p >> EC_PROB_SHIFT) >>
    (7 − EC_PROB_SHIFT)) +
    EC_MIN_PROB * n);
}
```

The scaled CDF 1008, an offset 1010, and a current bit 1012 of the bypass symbol are input to a selector/adder function 1014, which updates an entropy value corresponding to the current bit 1012. The selector/adder function 1014 compares the offset 1010 with the midpoint value given the bit value (i.e., the current bit 1012) to be encoded. The midpoint is conditionally subtracted from the offset, and range 1002 is set to either (range−midpoint) or (midpoint−0). The offset 1010 points to (e.g., indicates) the current location within the range 1002. A normalization function 1016 outputs a normalized offset 1018 and a normalized range 1020, which are then used as the offset 1010 and the range 1020, respectively. If the range is below 32768, then a normalization function 1066 performs a renormalization by shifting the range 1002 right by one (1) to obtain the normalized range 1020 and updating the offset. The technique 1000 then returns to the CDF scaling function 1006 to process multiple symbols.

FIG. 10B illustrates a traditional technique 1050 for decoding a bypass symbol from a compressed bitstream. The bypass symbol may include (e.g., may be composed of) multiple bits. A CDF scaling function 1056 receives a range 1052 of the bypass symbol to be decoded and a bypass CDF 1054. As mentioned above, the range is used to keep track of the width of a current interval; and the bypass CDF 1054 can be fixed CDF of {32768, 16384, 0|}. The CDF scaling function 1056 outputs a scaled CDF 1058. The scaled CDF 1058 can be {range, midpoint, 0}, where the midpoint value is calculated as described above.

The scaled CDF 1058 and an offset 1060 are input to a comparator/subtractor function 1062, which outputs (e.g., obtains) a bit 1064 of the bypass symbol based on a current entropy value. The comparator/subtractor function 1062 compares the offset 1060 with the midpoint value, with the result determining the decoded bit value. The midpoint is conditionally subtracted from the offset, and range is set to either (range−midpoint) or (midpoint−0).

A normalization function 1066 outputs a normalized offset 1068 and a normalized range 1070, which are then used as the offset 1060 and the range 1052, respectively. If the range is below 32768, then normalization function 1066 performs a renormalization by shifting the range 1052 right by one (1) and updating the offset. The technique 1050 then returns to the CDF scaling function 1056 to process multiple symbols.

These traditional approaches to bypass coding are suboptimal. Due to the number of calculations (including scaling and complex range normalization), it may not be possible to code no more than 2 symbols in a hardware cycle. Additionally, the scaling function may result in asymmetric probabilities. To illustrate, after scaling, the probabilities may become 49.9% and 50.1% (instead of remaining at 50%), which can have an impact on whether less than 1 bit or greater than one bit is coded (e.g., consumed from the bitstream or written to the bitstream).

Implementations according to this disclosure can improve throughput and accuracy of an arithmetic coder for coding equi-probable symbols. For example, with an arithmetic coder according to this disclosure, eight or more equi-probable symbols may be decoded per hardware cycle. Additionally, normalizing the range (and/or offset) are implemented with reduced computation complexity while improving the accuracy of the normalization (e.g., the probabilities remain at 50%). To reiterate, entropy bypass coding as described herein avoids scaling of the CDF; avoids complex normalization; and prevents asymmetric CDFs, which result from the scaling. Additionally, a decoding process that can look ahead a certain number of bypass symbols in the compressed bitstream without advancing the bitstream. Additionally, entropy bypass coding as described herein can be neutral to the coding efficiency as compared with traditional approaches to entropy bypass coding. In an example, bypass decoding may include the steps of receiving a number of bits to code, calculating a midpoint value of a range to obtain a cumulative distribution function, conditionally subtracting the midpoint from an offset, and normalizing at least one of the range or the offset.

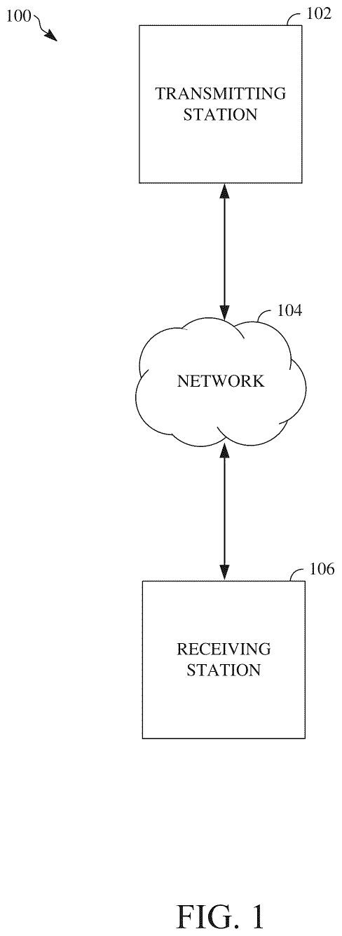

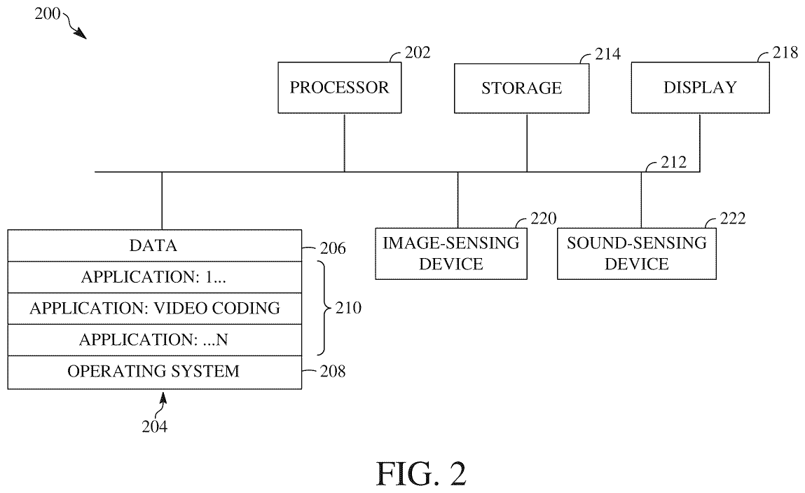

Further details of techniques for entropy bypass coding are described herein with initial reference to a system in which they can be implemented. FIG. 1 is a schematic of a video encoding and decoding system 100. A transmitting station 102 can be, for example, a computer having an internal configuration of hardware such as that described in FIG. 2. However, other suitable implementations of the transmitting station 102 are possible. For example, the processing of the transmitting station 102 can be distributed among multiple devices.

A network 104 can connect the transmitting station 102 and a receiving station 106 for encoding and decoding of the video stream. Specifically, the video stream can be encoded in the transmitting station 102, and the encoded video stream can be decoded in the receiving station 106. The network 104 can be, for example, the Internet. The network 104 can also be a local area network (LAN), wide area network (WAN), virtual private network (VPN), cellular telephone network, or any other means of transferring the video stream from the transmitting station 102 to, in this example, the receiving station 106.

The receiving station 106, in one example, can be a computer having an internal configuration of hardware such as that described in FIG. 2. However, other suitable implementations of the receiving station 106 are possible. For example, the processing of the receiving station 106 can be distributed among multiple devices.

Other implementations of the video encoding and decoding system 100 are possible. For example, an implementation can omit the network 104. In another implementation, a video stream can be encoded and then stored for transmission at a later time to the receiving station 106 or any other device having memory. In one implementation, the receiving station 106 receives (e.g., via the network 104, a computer bus, and/or some communication pathway) the encoded video stream and stores the video stream for later decoding. In an example implementation, a real-time transport protocol (RTP) is used for transmission of the encoded video over the network 104. In another implementation, a transport protocol other than RTP may be used, e.g., a Hypertext Transfer Protocol-based (HTTP-based) video streaming protocol.

When used in a video conferencing system, for example, the transmitting station 102 and/or the receiving station 106 may include the ability to both encode and decode a video stream as described below. For example, the receiving station 106 could be a video conference participant who receives an encoded video bitstream from a video conference server (e.g., the transmitting station 102) to decode and view and further encodes and transmits his or her own video bitstream to the video conference server for decoding and viewing by other participants.

FIG. 2 is a block diagram of an example of a computing device 200 that can implement a transmitting station or a receiving station. For example, the computing device 200 can implement one or both of the transmitting station 102 and the receiving station 106 of FIG. 1. The computing device 200 can be in the form of a computing system including multiple computing devices, or in the form of one computing device, for example, a mobile phone, a tablet computer, a laptop computer, a notebook computer, a desktop computer, and the like.

A CPU 202 in the computing device 200 can be a conventional central processing unit. Alternatively, the CPU 202 can be any other type of device, or multiple devices, capable of manipulating or processing information now existing or hereafter developed. Although the disclosed implementations can be practiced with one processor as shown (e.g., the CPU 202), advantages in speed and efficiency can be achieved by using more than one processor.

A memory 204 in computing device 200 can be a read only memory (ROM) device or a random access memory (RAM) device in an implementation. Any other suitable type of storage device can be used as the memory 204. The memory 204 can include code and data 206 that is accessed by the CPU 202 using a bus 212. The memory 204 can further include an operating system 208 and application programs 210, the application programs 210 including at least one program that permits the CPU 202 to perform the methods described herein. For example, the application programs 210 can include applications 1 through N, which further include a video coding application that performs the techniques described here, such as the techniques for bypass coding of symbols. Computing device 200 can also include a secondary storage 214, which can, for example, be a memory card used with a mobile computing device. Because the video communication sessions may contain a significant amount of information, they can be stored in whole or in part in the secondary storage 214 and loaded into the memory 204 as needed for processing.

The computing device 200 can also include one or more output devices, such as a display 218. The display 218 may be, in one example, a touch sensitive display that combines a display with a touch sensitive element that is operable to sense touch inputs. The display 218 can be coupled to the CPU 202 via the bus 212. Other output devices that permit a user to program or otherwise use the computing device 200 can be provided in addition to or as an alternative to the display 218. When the output device is or includes a display, the display can be implemented in various ways, including by a liquid crystal display (LCD), a cathode-ray tube (CRT) display, or a light emitting diode (LED) display, such as an organic LED (OLED) display.

The computing device 200 can also include or be in communication with an image-sensing device 220, for example, a camera, or any other image-sensing device 220 now existing or hereafter developed that can sense an image such as the image of a user operating the computing device 200. The image-sensing device 220 can be positioned such that it is directed toward the user operating the computing device 200. In an example, the position and optical axis of the image-sensing device 220 can be configured such that the field of vision includes an area that is directly adjacent to the display 218 and from which the display 218 is visible.

The computing device 200 can also include or be in communication with a sound-sensing device 222, for example, a microphone, or any other sound-sensing device now existing or hereafter developed that can sense sounds near the computing device 200. The sound-sensing device 222 can be positioned such that it is directed toward the user operating the computing device 200 and can be configured to receive sounds, for example, speech or other utterances, made by the user while the user operates the computing device 200.

Although FIG. 2 depicts the CPU 202 and the memory 204 of the computing device 200 as being integrated into one unit, other configurations can be utilized. The operations of the CPU 202 can be distributed across multiple machines (wherein individual machines can have one or more processors) that can be coupled directly or across a local area or other network. The memory 204 can be distributed across multiple machines such as a network-based memory or memory in multiple machines performing the operations of the computing device 200. Although depicted here as one bus, the bus 212 of the computing device 200 can be composed of multiple buses. Further, the secondary storage 214 can be directly coupled to the other components of the computing device 200 or can be accessed via a network and can comprise an integrated unit such as a memory card or multiple units such as multiple memory cards. The computing device 200 can thus be implemented in a wide variety of configurations.

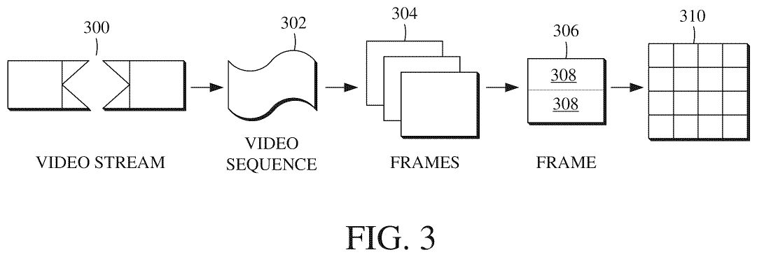

FIG. 3 is a diagram of an example of a video stream 300 to be encoded and subsequently decoded. The video stream 300 includes a video sequence 302. At the next level, the video sequence 302 includes a number of adjacent frames 304. While three frames are depicted as the adjacent frames 304, the video sequence 302 can include any number of adjacent frames 304. The adjacent frames 304 can then be further subdivided into individual frames, for example, a frame 306. At the next level, the frame 306 can be divided into a series of planes or segments 308. The segments 308 can be subsets of frames that permit parallel processing, for example. The segments 308 can also be subsets of frames that can separate the video data into separate colors. For example, a frame 306 of color video data can include a luminance plane and two chrominance planes. The segments 308 may be sampled at different resolutions.

Whether or not the frame 306 is divided into segments 308, the frame 306 may be further subdivided into blocks 310, which can contain data corresponding to, for example, 16×16 pixels in the frame 306. The blocks 310 can also be arranged to include data from one or more segments 308 of pixel data. The blocks 310 can also be of any other suitable size such as 4×4 pixels, 8×8 pixels, 16×8 pixels, 8×16 pixels, 16×16 pixels, or larger. Unless otherwise noted, the terms block and macroblock are used interchangeably herein.

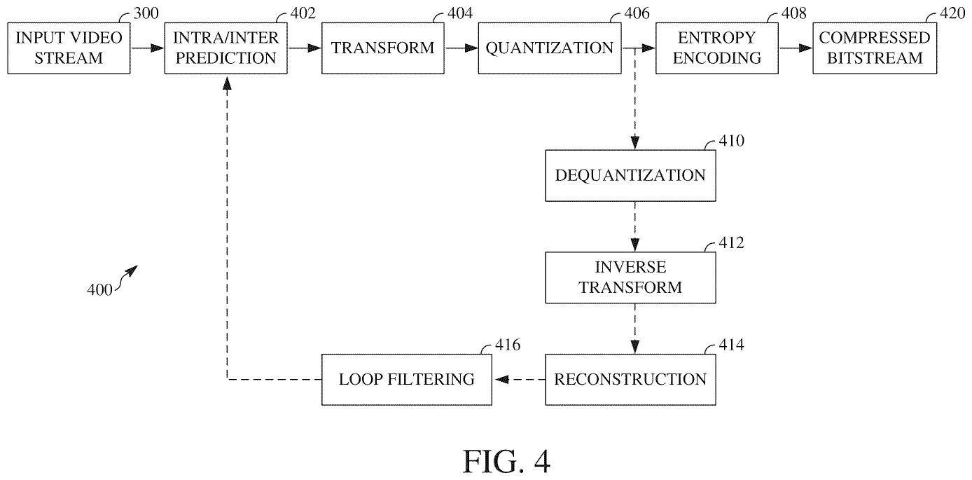

FIG. 4 is a block diagram of an encoder 400 according to implementations of this disclosure. The encoder 400 can be implemented, as described above, in the transmitting station 102, such as by providing a computer software program stored in memory, for example, the memory 204. The computer software program can include machine instructions that, when executed by a processor such as the CPU 202, cause the transmitting station 102 to encode video data in the manner described in FIG. 4. The encoder 400 can also be implemented as specialized hardware included in, for example, the transmitting station 102. In one particularly desirable implementation, the encoder 400 is a hardware encoder.

The encoder 400 has the following stages to perform the various functions in a forward path (shown by the solid connection lines) to produce an encoded or compressed bitstream 420 using the video stream 300 as input: an intra/inter prediction stage 402, a transform stage 404, a quantization stage 406, and an entropy encoding stage 408. The encoder 400 may also include a reconstruction path (shown by the dotted connection lines) to reconstruct a frame for encoding of future blocks. In FIG. 4, the encoder 400 has the following stages to perform the various functions in the reconstruction path: a dequantization stage 410, an inverse transform stage 412, a reconstruction stage 414, and a loop filtering stage 416. Other structural variations of the encoder 400 can be used to encode the video stream 300.

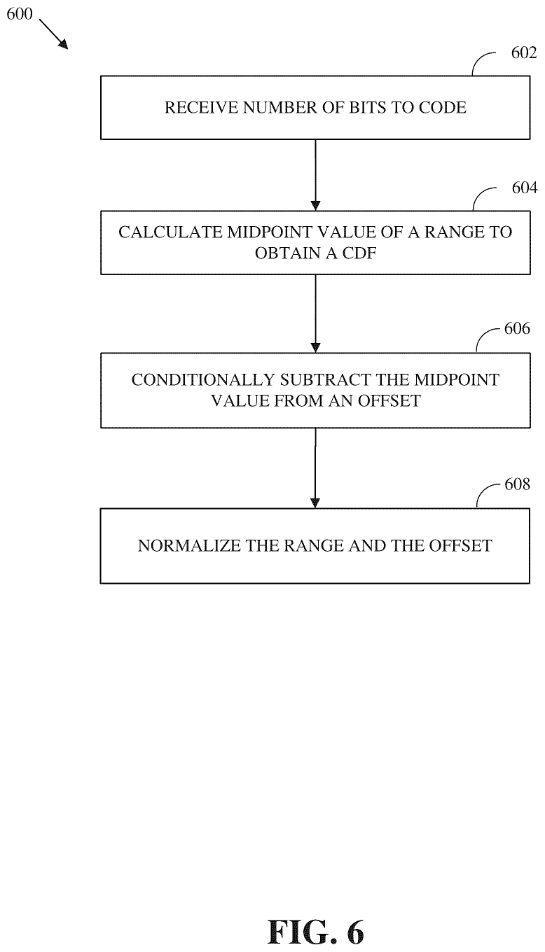

When the video stream 300 is presented for encoding, respective adjacent frames 304, such as the frame 306, can be processed in units of blocks. At the intra/inter prediction stage 402, respective blocks can be encoded using intra-frame prediction (also called intra-prediction) or inter-frame prediction (also called inter-prediction). In any case, a prediction block can be formed. In the case of intra-prediction, a prediction block may be formed from samples in the current frame that have been previously encoded and reconstructed. In the case of inter-prediction, a prediction block may be formed from samples in one or more previously constructed reference frames. Implementations for forming a prediction block are discussed below with respect to FIGS. 6, 7, and 8, for example, using parameterized motion model identified for encoding a current block of a video frame.

Next, still referring to FIG. 4, the prediction block can be subtracted from the current block at the intra/inter prediction stage 402 to produce a residual block (also called a residual). The transform stage 404 transforms the residual into transform coefficients in, for example, the frequency domain using block-based transforms. The quantization stage 406 converts the transform coefficients into discrete quantum values, which are referred to as quantized transform coefficients, using a quantizer value or a quantization level. For example, the transform coefficients may be divided by the quantizer value and truncated. The quantized transform coefficients are then entropy encoded by the entropy encoding stage 408. The entropy-encoded coefficients, together with other information used to decode the block (which may include, for example, the type of prediction used, transform type, motion vectors and quantizer value), are then output to the compressed bitstream 420. The compressed bitstream 420 can be formatted using various techniques, such as variable length coding (VLC) or arithmetic coding. The compressed bitstream 420 can also be referred to as an encoded video stream or encoded video bitstream, and the terms will be used interchangeably herein.

The reconstruction path in FIG. 4 (shown by the dotted connection lines) can be used to ensure that the encoder 400 and a decoder 500 (described below) use the same reference frames to decode the compressed bitstream 420. The reconstruction path performs functions that are similar to functions that take place during the decoding process (described below), including dequantizing the quantized transform coefficients at the dequantization stage 410 and inverse transforming the dequantized transform coefficients at the inverse transform stage 412 to produce a derivative residual block (also called a derivative residual). At the reconstruction stage 414, the prediction block that was predicted at the intra/inter prediction stage 402 can be added to the derivative residual to create a reconstructed block. The loop filtering stage 416 can be applied to the reconstructed block to reduce distortion such as blocking artifacts.

Other variations of the encoder 400 can be used to encode the compressed bitstream 420. For example, a non-transform based encoder can quantize the residual signal directly without the transform stage 404 for certain blocks or frames. In another implementation, an encoder can have the quantization stage 406 and the dequantization stage 410 combined in a common stage.

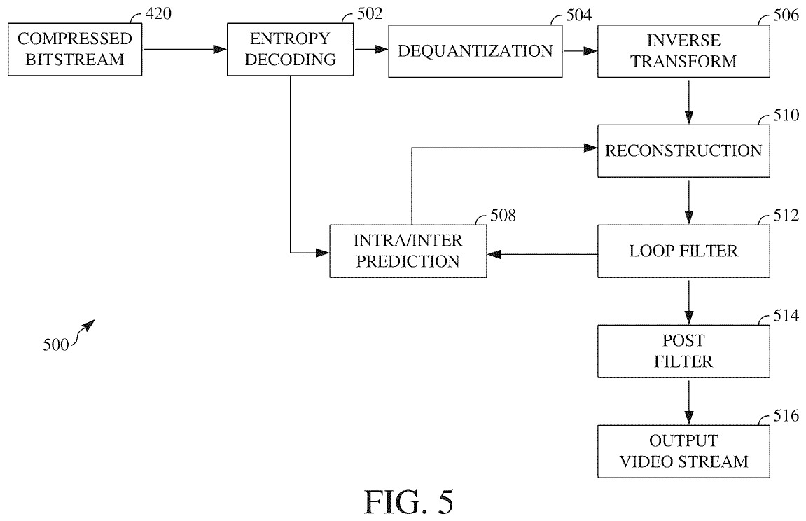

FIG. 5 is a block diagram of a decoder 500 according to implementations of this disclosure. The decoder 500 can be implemented in the receiving station 106, for example, by providing a computer software program stored in the memory 204. The computer software program can include machine instructions that, when executed by a processor such as the CPU 202, cause the receiving station 106 to decode video data in the manner described in FIG. 5. The decoder 500 can also be implemented in hardware included in, for example, the transmitting station 102 or the receiving station 106.

The decoder 500, similar to the reconstruction path of the encoder 400 discussed above, includes in one example the following stages to perform various functions to produce an output video stream 516 from the compressed bitstream 420: an entropy decoding stage 502, a dequantization stage 504, an inverse transform stage 506, an intra/inter prediction stage 508, a reconstruction stage 510, a loop filtering stage 512, and a post filtering stage 514. Other structural variations of the decoder 500 can be used to decode the compressed bitstream 420.

When the compressed bitstream 420 is presented for decoding, the data elements within the compressed bitstream 420 can be decoded by the entropy decoding stage 502 to produce a set of quantized transform coefficients. The dequantization stage 504 dequantizes the quantized transform coefficients (e.g., by multiplying the quantized transform coefficients by the quantizer value), and the inverse transform stage 506 inverse transforms the dequantized transform coefficients to produce a derivative residual that can be identical to that created by the inverse transform stage 412 in the encoder 400. Using header information decoded from the compressed bitstream 420, the decoder 500 can use the intra/inter prediction stage 508 to create the same prediction block as was created in the encoder 400, e.g., at the intra/inter prediction stage 402. At the reconstruction stage 510, the prediction block can be added to the derivative residual to create a reconstructed block. The loop filtering stage 512 can be applied to the reconstructed block to reduce blocking artifacts.

Other filtering can be applied to the reconstructed block. In this example, the post filtering stage 514 is applied to the reconstructed block to reduce blocking distortion or perform other post-processing on a frame, and the result is output as the output video stream 516. The output video stream 516 can also be referred to as a decoded video stream, and the terms will be used interchangeably herein. Other variations of the decoder 500 can be used to decode the compressed bitstream 420. For example, the decoder 500 can produce the output video stream 516 without the post filtering stage 514 or by omitting filtering in the post filtering state 514.

FIG. 6 is a flowchart diagram of a technique 600 for bypass coding of equi-probable symbols. The technique 600 can be implemented in a decoder, such as the decoder 500 of FIG. 5. The technique 600 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 600. In at least some implementations, the technique 600 can be performed in whole or in part by the entropy decoding stage 502 of the decoder 500 of FIG. 5.

The technique 600 can be implemented using specialized hardware or firmware. Some computing devices can have multiple memories, multiple processors, or both. The steps or operations of the technique 600 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

As is known, (binary) arithmetic coding is characterized by recursive interval division of a probability model. The AC may maintain two values: A range and an offset. The range register can be used to keep track of the width of a current interval; and the offset can be used to indicate a current location within the range.

At 602, a number of bits N to be decoded is received. The technique 600 can determine N based on a known maximum value of the value to be decoded.

At 604, a midpoint value is calculated as the midpoint within a current range. Thus, midpoint can be calculated as range/2. This in turn results in a CDF of {range, range/2, 0}. At 606, the midpoint value is conditionally subtracted from the offset. That is, the offset is compared with the midpoint value and, if the offset is greater than or equal to the midpoint value, then the offset can be set to: offset=offset−midpoint value; and if the offset is less than the midpoint value, then the offset is unchanged. At 608, at least one of the range or the offset may be normalized. The technique 600 then returns to step 604 to process multiple (e.g., additional) symbols.

In some implementations, the technique 600 requires that the range is always a multiple of 2. As such, for non-bypass symbols, the lowest significant bit (LSB) of the range may be set to 0 after scaling, as shown in the pseudocode of Table II. Causing the LSB to be set to zero can be accomplished via the operation “&˜1,” which represents a bitwise ‘AND’ operation with the bitwise negation of 1 therewith rounding down the range value to the nearest even number.

TABLE II

```
unsigned od_ec_prob_scale (uint16_t p, unsigned r, int n) {
  return (((r >> 8) * (uint32_t)(p >> EC_PROB_SHIFT) >>
      (7 − EC_PROB_SHIFT)) +
    EC_MIN_PROB * n) & ~1;
}
```

Table III illustrates a function od_ec_decode_literal_bypass( ) that further elaborates on the technique 600 for decoding a literal of n_bits. It is noted that the disclosure herein is not limited to or by the specific implementation shown in Table III and that other implementations are possible. The function od_ec_decode_literal_bypass( ) of Table III receives as input the value n_bits, which indicates the number of bits needed to represent the literal. In an example, n_bits can be a value in the range [1, 15]. The function od_ec_decode_literal_bypass( ) returns the value to be decoded, which is in the range of [0, 2^{n_bits-1}]. The value to be decoded is accumulated in the variable ret.

In Table III, the variables vw (e.g., a decoding range) and dif are, respectively, a scaled version of the range and the offset of the technique 600; and dec is a data structure that holds the state of the entropy decoder. The state of the entropy decoder can include the current range and offset (i.e., either an initial range and offset or the range and the offset immediately following the last consumed bits from the bitstream). At lines 7 and 8, the variable dif and r are initialized (e.g., copied from) the respective values in the decoder state, dec.

TABLE III

| | |
|---|---|
| 1 | int od_ec_decode_literal_bypass(od_ec_dec *dec, int n_bits) { |
| 2 | if (dec->cnt < n_bits − 1) od_ec_dec_refill(dec); |
| 3 | od_ec_window dif; |
| 4 | od_ec_window vw; |
| 5 | unsigned r; |
| 6 | int ret; |
| 7 | dif = dec->dif; |
| 8 | r = dec->rng; |
| 9 | assert((r & 1) == 0); |
| | assert(dif >> (OD_EC_WINDOW_SIZE − 16) < r); |
| | assert(32768U <= r); |
| | assert(0 < n_bits && n_bits <= 32); |
| 10 | vw = (od_ec_window)r << (OD_EC_WINDOW_SIZE − 16); |
| 11 | ret = 0; |
| 12 | for (int bit = 0; bit < n_bits; bit++) { |
| 13 | vw >>= 1; |
| 14 | ret <<= 1; |
| 15 | if (dif >= vw) { |
| 16 | dif −= vw; |
| 17 | } else { |
| 18 | ret \|= 1; |
| 19 | } |
| 20 | } |
| 21 | return od_ec_dec_bypass_normalize(dec, dif, n_bits, ret); |
| 22 | } |

While the function od_ec_decode_literal_bypass( ) adjusts the variables dif, the range value r (which is equal to dec->rng) remains the same after this function. The vw variable is used to determine the threshold between a ‘0’ and a ‘1’. If dif is greater than or equal to vw, the bit is considered a ‘0’; otherwise, the bit is a ‘1’. In other implementations, the opposite can be implemented. That is, for example, If dif is greater than or equal to vw, the bit is considered a ‘1’; otherwise, the bit is a ‘0’. The loop between lines 12 and 20 reads consumed bits from bitstream. As can be seen, and as contrasted with the traditional approaches, no scaling is performed on the CDF as bits are being consumed.

At line 10, vw is calculated as r shifted left by (OD_EC_WINDOW_SIZE−16), then shifted right by 1. The value dif is an extended version of the “offset” with additional preloaded bits from the compressed bitstream. The dif value is OD_EC_WINDOW_SIZE bits (which can be 32 or 64 bits), while the normative “offset” value is only 16 bits. Changing the value of the constant OD_EC_WINDOW_SIZE (such as from 32 to 64) would not affect the outcome of the od_ec_decode_literal_bypass( ) function in principle. What changes would be the maximum number of bits (n_bits) that can be decoded within the loop of lines 12-20.

Assuming that OD_EC_WINDOW_SIZE=32, then the “offset” can be found as offset=(dif>>(32-16)). The range stored in the decoder state (i.e., dec->rng) can be normatively defined as a 16-bit value. However, vw is OD_EC_WINDOW_SIZE bits: vw=r<<(32−16). Thus, the 16 most significant bits (MSBs) of dif may be or equal to the offset and the 16 LSBs may be the next bits read from the bitstream (dif [31:0]→[offset [15:0] | next bits [15:0]]); and the 16 most significant bits (MSBs) of vw may be or equal to the range and the 16 LSBs may be the zero padded (vw [31:0]→[range [15:0] zero padding [15:0]]). At line 13, vw is shifted right by 1 to get the midpoint value for decoding the bypass bit. Comparing, at line 15, “dif>=(vw>>1)” is equivalent to comparing “offset>=(range>>1)” due to the zero padding of vw. An advantage of having the next_bits number of bits preloaded in this way is that normalization would not be needed until after decoding of all of the n_bits bypass bits.

To illustrate the operations of the function od_ec_decode_literal_bypass( ) of Table III, assume that no bits have been consumed from the bitstream, that the bitstream includes the value 561093 (i.e., the encoded data received and that is to be decoded) and that 6 bits (i.e., n_bits=6) are to be read from the bitstream. As such, the offset dif is then equal to 561093. Additionally, the range r may initially be set to the maximum initial range of 65535, which is the maximum range for a 16-bit prediction assumed in this illustration. The initial decoder state dec includes dif=561093 and the 16-bit range r value (after normalization) must be within [32768, 65536) (e.g., 65536 being just outside that range). In an implementation, the starting (initial) range r=32768.

Table IV illustrates the values of the different variables after each of the iterations between lines 12 and 20. Prior to the loop, vw is set to 65536 and dif is set to 561093.

At line 13, vw is halved to 32768. At line 14, ret is shifted left by 1 to make room for the next bit. By shifting left, the LSB of ret is 0. At line 15, dif (in this example, 561093) is greater than vw (32768). As such, line 16 is executed and the bit to be read is assumed to be 0. At line 16, dif is set to (dif=dif−vw)=24125. In the second iteration, vw is halved again to 16384 and ret is shifted left. As dif (24125) is greater than vw (16384), the bit is a ‘0’, and dif is updated to dif−vw=7741. In the third iteration, vw is halved again to 10192 and ret is shifted left. As dif (7741) is less than vw (10192), the bit is considered to be a ‘1’, and dif remains 7741. As the bit is considered to be a ‘1’, at line 18, the LSB of ret is set to 1. The same set of steps are repeated until all 6 bits are read and accumulated into ret. When all iterations complete, ret will contain the bitstring 001000. The final dif is 573 and the range r remains 65536.

TABLE IV

| Iteration | Bit # | vw | ret | dif |
|---|---|---|---|---|
| | — | 65536 | | 561093 |
| 1 | 1 | 32768 | 0 | 24125 |
| 2 | 2 | 16384 | 00 | 7741 |
| 3 | 3 | 10192 | 001 | 7741 |
| 4 | 4 | 4096 | 0010 | 3645 |
| 5 | 5 | 2048 | 00100 | 1597 |
| 6 | 6 | 1024 | 001000 | 573 |

Table V illustrates a function od_ec_encode_literal_bypass( ) for encoding a value given by the variable val in n_bits number of bits. The function od_ec_encode_literal_bypass( ) of Table V receives as input the variables n_bits and val. The function od_ec_encode_literal_bypass( ) encodes the value in a compressed bitstream.

TABLE V

| | |
|---|---|
| 1 | void od_ec_encode_literal_bypass(od_ec_enc *enc, int val, int n_bits) { |
| 2 | od_ec_window l; |
| 3 | unsigned r; |
| 4 | l = enc->low; |
| 5 | r = enc->rng; |
| 6 | assert(32768U <= r); |
| | assert((r & 1) == 0); |
| 7 | l <<= n_bits; |
| 8 | l += r * val; |
| 9 | od_ec_enc_normalize(enc, l, r, n_bits); |
| 10 | } |

In the function od_ec_encode_literal_bypass( ), bypass coding is mainly implemented by lines 7-8. In Table V, l is the offset indicating the starting point of the range currently held by the encoder state data structure, enc. The range r is typically the maximum range minus the low value (i.e., the offset). In this particular example, and as indicated by the assertion of line 6, the range r should be at least 32768. Again, the argument val is the value to be encoded in a number of bits given by the argument n_bits. For example, and corresponding to the foregoing example, val can be 8 (i.e., the binary value 001000) and is to be encoded in 6 bits (n_bits=6).

At line 7, the offset l is shifted by n_bits (e.g., 6 bits in this case) to make room for the new bits. At line 8, the value val is scaled (i.e., r*val) by the current range r and the product is added into the offset (i.e., 1+=r*val) therewith effectuating the direct, bypass encoding of the value val. That is, val is simply added directly to the encoded output, scaled by the current range. At line 9, od_ec_enc_normalize( ) is called to re-normalize the range (for example if the range falls below a certain threshold) and to output bits to the bitstream. The od_ec_enc_normalize( ) function keeps track of the number of bits (n_bits) that have been encoded into the variable l. When the number of accumulated bits exceeds a threshold N, the upper N bits of the variable l can then be sent to an output buffer, and those N bits are then set to zero in the variable l. Since the range value is known to remain the same value after bypass coding, this value is not modified by the od_ec_encode_literal_bypass( ) function and no additional range adjustment is needed in the function od_ec_enc_normalize( ).

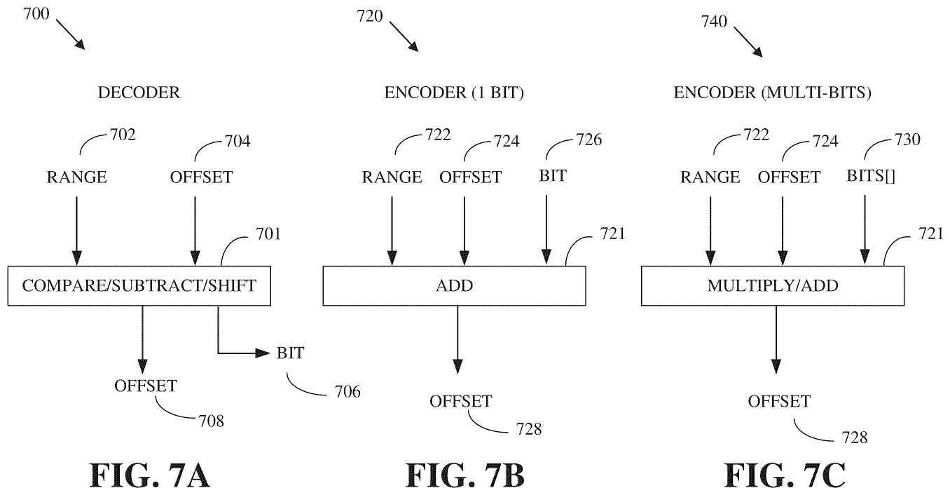

FIG. 7A is a diagram 700 of decoding a bypass symbol according to implementations of this disclosure. FIG. 7B is a diagram 720 of encoding a single-bit bypass symbol according to implementations of this disclosure. FIG. 7C is a diagram 740 of encoding a multi-bit bypass symbol according to implementations of this disclosure.

In the diagram 700, a bypass arithmetic decoder 701 uses a decoder range 702 and an offset 704 to decode (e.g., consume or read) a binary bit value from a compressed bitstream, such as the compressed bitstream 420 of FIG. 5. The decoder range 702 and the offset 704 can be as described with respect to the variables r and dif of the function ec_decode_literal_bypass( ) of Table III, respectively. After decoding one bit (i.e., a bit 706), the bypass arithmetic decoder 701 conditionally updates the offset 704 to obtain an offset 708.

In the diagram 720, a bypass arithmetic encoder 721 uses a decoder range 722 and an offset 724 to encode (e.g., write) a binary bit value into a compressed bitstream, such as the compressed bitstream 420 of FIG. 4. The bypass arithmetic encoder 721 is shown as including an “ADD” operation, which essentially corresponds to the line 8 of the function od_ec_encode_literal_bypass( ) of Table V. In the case that one bit is being encoded, the statement 1+=r*val essentially reduces to 1+=r. After the one bit 726 is encoded, the offset 724 is conditionally updated to produce an offset 728. The diagram 740 is distinguished from the diagram 720 in that the bypass arithmetic encoder 721 receives more than one bit (i.e., bits 730) to encode.

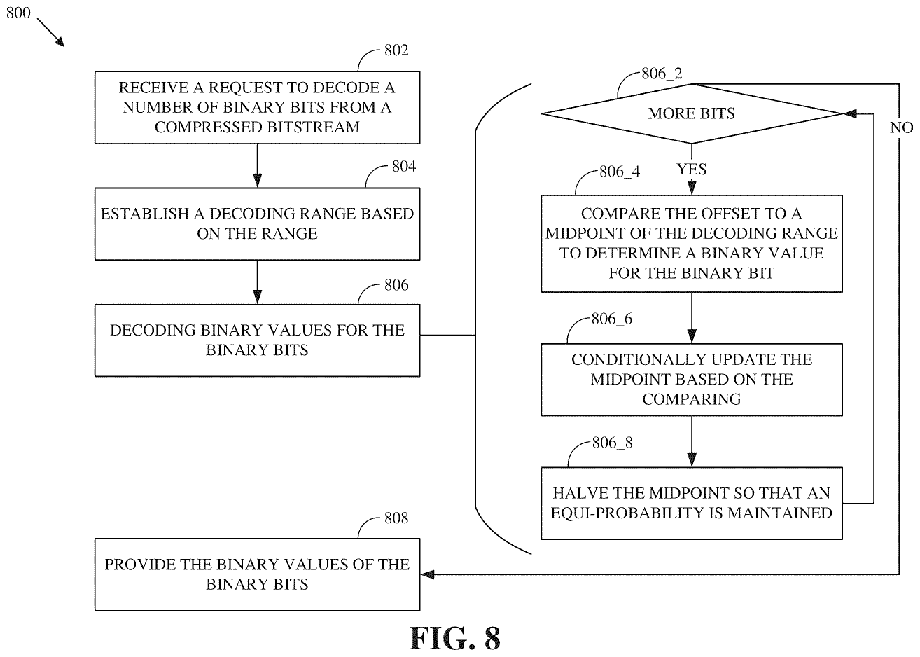

FIG. 8 is a flowchart diagram of a technique 800 for bypass decoding of equi-probable symbols. The technique 800 can be implemented in a decoder, such as the decoder 500 of FIG. 5. The technique 800 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 800. In at least some implementations, the technique 800 can be performed in whole or in part by the entropy decoding stage 502 of the decoder 500 of FIG. 5. The technique 800 can be implemented by an arithmetic decoder, such as the bypass arithmetic decoder 701 of FIG. 7A.

The technique 800 can be implemented using specialized hardware or firmware. Some computing devices can have multiple memories, multiple processors, or both. The steps or operations of the technique 800 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

At 802, a request to decode a number of binary bits from a compressed bitstream is received, where each of the binary bits is equi-probable. The arithmetic decoder maintains an offset and a range, which can be as described above. The range is restricted to even numbers, particularly those that are powers of 2. At 804, a decoding range can be established (e.g., set, selected, configured, etc.) based on the range. In an example, the range itself can be used as the decoding range. In an example, the decoding range may be a scaled up version of the range, such as described with respect to line 10 of Table III. In an example, the decoding range can be maintained between a lower limit of 32,768 and an upper limit of 65,535. As further described herein, the offset can be utilized to decode bits from the compressed bitstream and is considered (e.g., set to) a lowest value in the decoding range.

At 806, the binary values are decoded. Decoding the binary values can include performing steps 806_4 to 806_8 for each bit. As such, at 806_2, it is determined whether more bits remain to be decoded. If there are more bits to decode, then the technique 800 proceeds to 806_4; otherwise the technique 800 resumes at 808. At 808, the technique 800 provides (e.g., returns) the binary values (such as to a requester or invoker of the technique 800). That is the technique 800 may provide a binary string that includes the decoded bits.

At 806_4, the offset is compared to a midpoint of the decoding range to determine a binary value for the each binary bit. The comparing can be as described with respect to line 15 of Table III. At 806_6, the midpoint is conditionally updated based on the comparing. For example, and as described with respect to lines 15-10 of Table III, in response to determining that the offset is greater than or equal to the midpoint of the decoding range, the (decoded) binary bit is set to a particular binary value and the offset is set to a value determined by subtracting the midpoint from the offset; and in response to determining that the offset is less than the midpoint of the decoding range, the binary bit is set to a complement of the particular binary value and the offset is not updated. In some implementations, the particular binary value is 0 (and its complement is 1). In other implementations, the particular binary value is 1 (and its complement is 0). As such, conditionally updating the midpoint based on the comparing can include setting the offset to a value determined by subtracting the midpoint from the offset if a decoded bit value corresponds to a particular portion of the range, otherwise maintaining the offset, as described above.

At 806_8, the midpoint is halved so that the equi-probability is maintained for decoding a next binary bit subsequent to the each binary bit. Halving the midpoint can be performed using a right bit shift operation, such as described with respect to line 13 of Table III. As described above, halving the midpoint constitutes a normalization step such that a lowest significant bit of the decoding range is always set to zero.

The binary bits can be used to decode (or can relate to) respective sign bits of non-zero coefficients of a transform block. Coding the coefficients values of a quantized transform block may include coding what is referred to as a sign map. The sign map indicates for the non-zero coefficients of the quantized transform block which of the coefficients are positive and which are negative. The sign map may be coded as a bit string where 1 may indicate that the coefficient is positive and 0 may indicate that the coefficient is negative (or vice versa).

The binary bits can be used to decode (or can relate to) a Golomb-coded transform coefficient level. To illustrate, transform coefficients may be coded in levels (e.g., in three level planes). The three level planes may be a lower-level, a middle-level, and a higher-level planes. The lower-, middle-, and higher-level planes correspond to different ranges of coefficient magnitudes (0-2, 3-14, 15 and above, respectively). The remainder (coefficient magnitude minus 14) is entropy coded using a Golomb code.

The binary bits can be used to decode (or can relate to) a position of an end-of-block (EOB). Given a scan order for traversing a quantized transform coefficient, the EOB indicates the scan order position of the last non-zero coefficient of the quantized transform coefficient. Coding the position of the EOB may include coding a range of scan positions and then an offset within the range. The range may be coded using a CDF selected based on a context and the offset may be bypass coded.

The binary bits can be used to decode (or can relate to) loop filter parameters. To illustrate, an encoded bitstream may include data indicating which, if any, of available filters are to be applied, such as by one of the loop filtering stage 512 or the post filtering stage 514 of FIG. 5. To illustrate, and using the AV1 codec as an example, the available (optional) filters may include a Constrained directional enhancement filter (CDEF), a Weiner filter, a self-guided filter, and a frame super resolution filter. The binary bits can be used to decode (or can relate to) a palette color list. For example, a color palette that includes a number (e.g., 2 to 8) base colors (i.e., pixel value) may be built for a luma and/or chroma plane and each pixel is assigned a color index into the palette. The color values of the palette may be bypass coded.

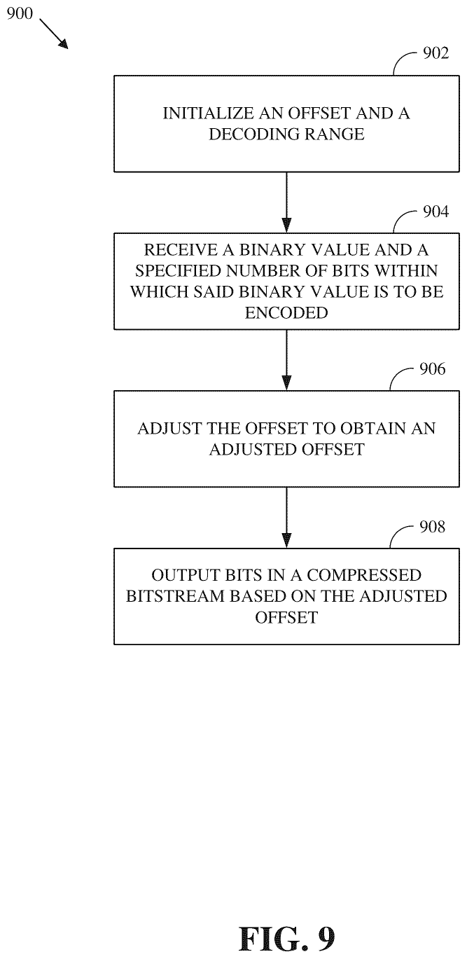

FIG. 9 is a flowchart diagram of a technique 900 for bypass encoding of equi-probable symbols. The technique 900 can be implemented in an encoder, such as the encoder 400 of FIG. 4. The technique 900 can be implemented, for example, as a software program that can be executed by computing devices such as transmitting station 102 or the receiving station 106 of FIG. 1. The software program can include machine-readable instructions (e.g., executable instructions) that can be stored in a memory such as the memory 204 or the secondary storage 214, and that can be executed by a processor, such as CPU 202, to cause the computing device to perform the technique 900. In at least some implementations, the technique 900 can be performed in whole or in part by the entropy encoding stage 408 of the encoder 400 of FIG. 4. The technique 900 can be implemented by an arithmetic encoder, such as the bypass arithmetic encoder 721 of FIG. 7B or 7C.

The technique 900 can be implemented using specialized hardware or firmware. Some computing devices can have multiple memories, multiple processors, or both. The steps or operations of the technique 900 can be distributed using different processors, memories, or both. Use of the terms “processor” or “memory” in the singular encompasses computing devices that have one processor or one memory as well as devices that have multiple processors or multiple memories that can be used in the performance of some or all of the recited steps.

At 902, an offset (value) and a decoding range (value) are initialized. The offset and the decoding range can be as described with respect to the variables l and r, respectively, of the function od_ec_encode_literal_bypass( ) of Table V. At 904, a binary value and a specified number of bits within which the binary value is to be encoded are received. The specified number of bits is limited to a predetermined maximum value. As described above, the range is repeatedly halved. Thus, in the case of 16-bit precision, the range may be initialized to 32768 and the predetermined maximum value may be 15 as it would not be possible to half the range further after 15 splits.

At 906, the offset is adjusted to obtain an adjusted offset based on the binary value and the specified number of bits by performing a leftward bit shift operation on the offset followed by an addition of a product of the decoding range and the binary value. At 908, bits are output to a compressed bitstream based on the adjusted offset.

The technique 900 may further include normalizing at least one of the offset or the decoding range by invoking a normalization function that takes as parameters the adjusted offset, the range value, and the specified number of bits. The normalization facilitates the accommodation of the binary value within the specified number of bits while maintaining data integrity during compression. That is, the normalization function can be designed to prevent overflow or underflow conditions in the decoding range or the offset by adjusting the range and the offset.

For simplicity of explanation, the techniques 600, 800, and 900 of FIGS. 6, 8, and 9, respectively, are each depicted and described as a respective series of steps or operations. However, the steps or operations in accordance with this disclosure can occur in various orders and/or concurrently. Additionally, other steps or operations not presented and described herein may be used. Furthermore, not all illustrated steps or operations may be required to implement a method in accordance with the disclosed subject matter.

The disclosure presented herein may be considered in view of the following clauses.

Example Clause A: A method for bypass decoding by an arithmetic decoder, comprising: receiving a request to decode a number of binary bits from a compressed bitstream, wherein each of the binary bits is equi-probable, and wherein the arithmetic decoder maintains an offset and a range; establishing a decoding range based on the range; decoding binary values for the binary bits by: for each binary bit of the binary bits, performing steps comprising: comparing the offset to a midpoint of the decoding range to determine a binary value for the each binary bit, wherein the binary value is decoded from the compressed bitstream; conditionally updating the midpoint based on the comparing; and halving the midpoint so that an equi-probability is maintained for decoding a next binary bit subsequent to the each binary bit; and providing the binary values of the binary bits.

Example Clause B: The method of Example Clause A, further comprising: in response to determining that the offset is greater than or equal to the midpoint of the decoding range: setting the each binary bit to a particular binary value; and setting the offset to a value determined by subtracting the midpoint from the offset; and in response to determining that the offset is less than the midpoint of the decoding range: setting the each binary bit to a complement of the particular binary value.

Example Clause C: The method of Example Clause A or Example Clause B, wherein the particular binary value is 0.

Example Clause D: The method of any one of Example Clauses A-C, wherein the particular binary value is 1.

Example Clause E: The method of any one of Example Clauses A-D, wherein halving the midpoint comprises: performing a right bit-shift operation on the midpoint.

Example Clause F: The method of any one of Example Clauses A-E, wherein conditionally updating the midpoint based on the comparing comprises: setting the offset to a value determined by subtracting the midpoint from the offset if a decoded bit value corresponds to a particular portion of the range, otherwise maintaining the offset.

Example Clause G: The method of any one of Example Clauses A-F, wherein the binary bits are utilized for decoding one of respective sign bits of non-zero coefficients of a transform block, Golomb-coded transform coefficient levels, an end-of-block (EOB) position of the transform block, loop filter parameters, or palette color list.

Example Clause H: The method of any one of Example Clauses A-G, wherein halving the midpoint constitutes a normalization step such that a lowest significant bit of the decoding range is always set to zero.

Example Clause I: The method of any one of Example Clauses A-H, wherein the decoding range is maintained between a lower limit of 32,768 and an upper limit of 65,535.

Example Clause J: The method of any one of Example Clauses A-I, wherein the offset is utilized to decode bits from the compressed bitstream and is a lowest value in the decoding range.

Example Clause K: A method for encoding binary values, comprising: initializing an offset and a decoding range; receiving a binary value and a specified number of bits within which the binary value is to be encoded, wherein the specified number of bits is limited to a predetermined maximum value; adjusting the offset to obtain an adjusted offset based on the binary value and the specified number of bits by performing a leftward bit shift operation on the offset followed by an addition of a product of the decoding range and the binary value; and outputting bits in a compressed bitstream based on the adjusted offset.

Example Clause L: The method of Example Clause K, further comprising: normalizing at least one of the offset or the decoding range by invoking a normalization function that takes as parameters the adjusted offset, the range, and the specified number of bits.

Example Clause M: The method of Example Clause K or Example Clause L, wherein the normalization function is designed to prevent overflow or underflow conditions by adjusting the decoding range and the offset.

Example Clause N: The method of any one of Example Clauses K-M, wherein the predetermined maximum value is sixteen.

Example Clause O: The method of any one of Example Clauses K-N, wherein the binary value is utilized for encoding one of respective sign bits of non-zero coefficients of a transform block, Golomb-coded transform coefficient levels, an end-of-block (EOB) position of the transform block, loop filter parameters, or palette color list.

Example Clause P: A method for bypass coding, comprising: receiving a number of bits to code; calculating a midpoint value of a range to obtain a cumulative distribution function; conditionally subtracting the midpoint from an offset; and normalizing at least one of the range or the offset.

The aspects of encoding and decoding described above illustrate some examples of encoding and decoding techniques. However, it is to be understood that encoding and decoding, as those terms are used in the claims, could mean compression, decompression, transformation, or any other processing or change of data.

The word “example” is used herein to mean serving as an example, instance, or illustration. Any aspect or design described herein as “example” is not necessarily to be construed as being preferred or advantageous over other aspects or designs. Rather, use of the word “example” is intended to present concepts in a concrete fashion. As used in this application, the term “or” is intended to mean an inclusive “or” rather than an exclusive “or.” That is, unless specified otherwise or clearly indicated otherwise by the context, the statement “X includes A or B” is intended to mean any of the natural inclusive permutations thereof. That is, if X includes A; X includes B; or X includes both A and B, then “X includes A or B” is satisfied under any of the foregoing instances. In addition, the articles “a” and “an” as used in this application and the appended claims should generally be construed to mean “one or more,” unless specified otherwise or clearly indicated by the context to be directed to a singular form. Moreover, use of the term “an implementation” or the term “one implementation” throughout this disclosure is not intended to mean the same embodiment or implementation unless described as such.

Implementations of the transmitting station 102 and/or the receiving station 106 (and the algorithms, methods, instructions, etc., stored thereon and/or executed thereby, including by the encoder 400 and the decoder 500) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably. Further, portions of the transmitting station 102 and the receiving station 106 do not necessarily have to be implemented in the same manner.

Further, in one aspect, for example, the transmitting station 102 or the receiving station 106 can be implemented using a general purpose computer or general purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

The transmitting station 102 and the receiving station 106 can, for example, be implemented on computers in a video conferencing system. Alternatively, the transmitting station 102 can be implemented on a server, and the receiving station 106 can be implemented on a device separate from the server, such as a handheld communications device. In this instance, the transmitting station 102, using an encoder 400, can encode content into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting station 102. Other suitable transmitting and receiving implementation schemes are available. For example, the receiving station 106 can be a generally stationary personal computer rather than a portable communications device, and/or a device including an encoder 400 may also include a decoder 500.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor (that is, the computer-readable medium can be a non-transitory computer-readable storage medium). The medium can be, for example, an electronic, magnetic, optical, electromagnetic, or semiconductor device. Other suitable mediums are also available.

The above-described embodiments, implementations, and aspects have been described in order to facilitate easy understanding of this disclosure and do not limit this disclosure. On the contrary, this disclosure is intended to cover various modifications and equivalent arrangements included within the scope of the appended claims, which scope is to be accorded the broadest interpretation as is permitted under the law so as to encompass all such modifications and equivalent arrangements.

1. A method for bypass decoding by an arithmetic decoder, comprising:
receiving a request to decode a number of binary bits from a compressed bitstream, wherein each of the binary bits is equi-probable, and wherein the arithmetic decoder maintains an offset and a range;
establishing a decoding range based on the range;
decoding binary values for the binary bits by:
for each binary bit of the binary bits, performing steps comprising:
comparing the offset to a midpoint of the decoding range to determine a binary value for the each binary bit, wherein the binary value is decoded from the compressed bitstream;
conditionally updating the midpoint based on the comparing; and
halving the midpoint so that an equi-probability is maintained for decoding a next binary bit subsequent to the each binary bit; and
providing the binary values of the binary bits.

2. The method of claim 1, further comprising:
in response to determining that the offset is greater than or equal to the midpoint of the decoding range:
setting the each binary bit to a particular binary value; and
setting the offset to a value determined by subtracting the midpoint from the offset; and
in response to determining that the offset is less than the midpoint of the decoding range:
setting the each binary bit to a complement of the particular binary value.

3. The method of claim 2, wherein the particular binary value is 0.

4. The method of claim 2, wherein the particular binary value is 1.

5. The method of claim 1, wherein conditionally updating the midpoint based on the comparing comprises:
setting the offset to a value determined by subtracting the midpoint from the offset if a decoded bit value corresponds to a particular portion of the range, otherwise maintaining the offset.

6. The method of claim 1, wherein halving the midpoint comprises:
performing a right bit-shift operation on the midpoint.

7. The method of claim 1, wherein the binary bits are utilized for decoding one of respective sign bits of non-zero coefficients of a transform block, Golomb-coded transform coefficient levels, an end-of-block (EOB) position of the transform block, loop filter parameters, or palette color list.

8. The method of claim 1, wherein halving the midpoint constitutes a normalization step such that a lowest significant bit of the decoding range is always set to zero.

9. The method of claim 1, wherein the decoding range is maintained between a lower limit of 32,768 and an upper limit of 65,535.

10. The method of claim 1, wherein the offset is utilized to decode bits from the compressed bitstream and is a lowest value in the decoding range.

11. A method for encoding binary values, comprising:
initializing an offset and a decoding range;
receiving a binary value and a specified number of bits within which the binary value is to be encoded, wherein the specified number of bits is limited to a predetermined maximum value;
adjusting the offset to obtain an adjusted offset based on the binary value and the specified number of bits by performing a leftward bit shift operation on the offset followed by an addition of a product of the decoding range and the binary value; and
outputting bits in a compressed bitstream based on the adjusted offset.

12. The method of claim 11, further comprising:
normalizing at least one of the offset or the decoding range by invoking a normalization function that takes as parameters the adjusted offset, the range, and the specified number of bits.

13. The method of claim 12, wherein the normalization function is designed to prevent overflow or underflow conditions by adjusting the decoding range and the offset.

14. The method of claim 11, wherein the predetermined maximum value is sixteen.

15. The method of claim 11, wherein the binary value is utilized for encoding one of respective sign bits of non-zero coefficients of a transform block, Golomb-coded transform coefficient levels, an end-of-block (EOB) position of the transform block, loop filter parameters, or palette color list.

16. A device, comprising:
a processor that is configured to perform the method of claim 1.

17. (canceled)

18. A non-transitory computer-readable storage medium, comprising executable instructions that, when executed by a processor, facilitate performance of the method of claim 1.

19. A non-transitory computer-readable storage medium having stored thereon an encoded bitstream, wherein the encoded bitstream is configured for decoding by the method of claim 1.

20. (canceled)

21. A device, comprising:
a memory; and
a processor, the processor configured to execute instructions stored in the memory to perform the method of claim 11.

22. (canceled)

23. (canceled)

24. A method for bypass coding, comprising:
receiving a number of bits to code;
calculating a midpoint value of a range to obtain a cumulative distribution function;
conditionally subtracting the midpoint from an offset; and
normalizing at least one of the range or the offset.
